(19) United States
(12) Patent Application Publication
(10) Pub. No.: US 2007/0133564 A1
(43) Pub. Date: Jun. 14, 2007

(54) Method for propagating maintenance signal in VPWS network using SDH/SONET

(76) Inventors: Kyung Gyu Chun, Daejeon (KR); Soon Seok Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/633,213

(22) Filed: Dec. 4, 2006

(30) Foreign Application Priority Data
Dec. 9, 2005 (KR) 10-2005-0120300

(51) Int. Cl. H04L 12/56; H04L 12/26

(52) U.S. Cl. 370/395.51; 370/236.2

(57) ABSTRACT

Provided is a method for propagating a maintenance signal that can notify an Ethernet layer as well as a VPWS, which is a multi-protocol label switching (MPLS) layer, that a defect has occurred when the defect occurs in a virtual private wire service (VPWS) network using synchronous digital hierarchy (SDH)/synchronous optical network (SONET) as a physical layer. The method includes the steps of: when a physical defect signal is detected from a physical layer, generating a physical layer alarm indication signal (AIS) and a physical layer remote defect indication (RDI) signal, and transmitting the physical layer RDI signal to a neighbor node in the backward direction of traffic; when the physical layer AIS is detected, generating and transmitting, at an MPLS layer, an MPLS backward defect indication (BDI) signal indicating a backward defect to an ingress node, and generating and transmitting, at an Ethernet layer, an Ethernet AIS to an Ethernet subscriber device connected to an egress node; and generating and transmitting, at the Ethernet subscriber device receiving the Ethernet AIS, an RDI signal indicating a backward Ethernet flow defect to an Ethernet subscriber device connected to the ingress node.

### CROSS-REFERENCE TO RELATED APPLICATION

This application claims priority to and the benefit of Korean Patent Application No. 2005-120300, filed Dec. 9, 2005, the disclosure of which is incorporated herein by reference in its entirety.

### BACKGROUND

1. Field of the Invention

The present invention relates to a method for systemically propagating a maintenance signal to a multi-protocol label switching (MPLS) layer and an Ethernet layer as well as a physical layer in a virtual private wire service (VPWS) network that uses synchronous digital hierarchy (SDH)/synchronous optical network (SONET) as the physical layer.

2. Discussion of Related Art

In a VPWS system, an Ethernet signal is encapsulated in an MPLS signal and mapped to an MPLS signal, and the MPLS signal is mapped to an SDH signal.

In general, maintenance signal propagation methods have been applied to SDH/SONET, which is synchronous optical transmission equipment, and optical transport hierarchy (OTH). For example, when a physical defect, such as optical cable disconnection between repeaters or between terminal equipment and a repeater, occurs in an SDH/SONET comprising a terminal multiplexer and several repeaters, the repeater inserts “1” in all parts of a synchronous transport module level (STM-N) frame excluding regenerator section overhead (RSOH) so that a multiplex section-alarm indication signal (MS-AIS), an administration unit alarm indication signal (AU-AIS), and a virtual container alarm indication signal (VC-AIS) are automatically generated.

Upon receipt of the MS-AIS, AU-AIS, and VC-AIS, the optical termination equipment recognizes that defect has occurred in a server layer, i.e., a regenerator section other than a multiplexing section or a path section, and does not have to report an alarm indicating the multiplex section or the path section defect, but just regenerator section defect such as the LOS (loss of signal) or LOF (loss of frame) has to be reported to network management equipment.

However, in an MPLS using SDH/SONET as a physical layer, there is no maintenance signal propagation system between the physical layer and an MPLS layer. In case of physical layer failure, a label switched path (LSP) defect is detected at an egress node of an LSP, which makes it difficult to exactly recognize the causes and reasons of defect.

Likewise, in a VPWS transferring an Ethernet signal using a VPWS LSP as a transmission medium, when a defect occurs in an Ethernet flow due to LSP defect, it is difficult to recognize causes of the Ethernet flow defect.

Therefore, with conventional SDH/SONET operation, administration and maintenance (OAM) technology, MPLS OAM technology, and Ethernet OAM technology, it is difficult to recognize a cause and occurrence location of a defect and to prevent a layer-specific defect from occurring due to a physical defect in a network.

### SUMMARY OF THE INVENTION

It is an object of the present invention to provide a method for propagating a maintenance signal, capable of notifying an Ethernet layer as well as a VPWS, which is a multi-protocol label switching (MPLS) layer, that a physical defect has occurred when the defect occurs in an apparatus accommodating a virtual private wire service (VPWS) signal in next generation-synchronous digital hierarchy (NG-SDH).

It is another object of the present invention to provide a method for propagating a layer-specific maintenance signal, allowing an appropriate action for each layer to be performed and allowing customer edge (CE) equipment as well as provider edge (PE) equipment provided by a network provider to perform end-to-end management.

One aspect of the present invention provides a method for propagating a maintenance signal in a VPWS network, comprising the steps of: when a physical defect signal is detected from a physical layer, generating physical layer maintenance signals including a physical layer alarm indication signal (AIS) and a physical layer remote defect indication (RDI) signal, and transmitting them to its peer node in the backward direction of traffic; when the physical layer AIS is detected, generating and transmitting, at an MPLS layer, an VPWS-BDI (backward defect indication) signal indicating a backward defect to an ingress node, and generating and transmitting, at an Ethernet layer, an Ethernet AIS to an Ethernet subscriber device connected to an egress node; and generating and transmitting, at the Ethernet subscriber device receiving the Ethernet AIS, an RDI signal indicating a backward Ethernet flow defect to an Ethernet subscriber device connected to the ingress node.

Preferably, the VPWS-BDI signal generated at the MPLS layer may have an MPLS-OAM packet structure, a backward defect or a forward defect may be set in a defect type field of the MPLS-OAM packet, and identification information of a node at which a first physical defect is detected may be recorded in a defect location field. The Ethernet maintenance signal generated at the Ethernet layer may have an Ethernet-OAM packet structure.

Preferably, when the physical defect signal is detected at the egress node, the physical layer RDI signal may be transmitted to a transit node, and when the physical defect signal is detected at the transit node, the physical layer RDI signal may be transmitted to the ingress node.

Preferably, when the physical defect signal is detected at the transit node, the MPLS layer may generate and transmit a VPWS-FDI signal indicating a forward defect to the egress node, and the Ethernet layer of the egress node receiving the VPWS-FDI signal may generate and transmit an Ethernet forward defect signal to the Ethernet subscriber device connected to the egress node.

Preferably, when the egress node receives the VPWS-FDI signal from the transit node or detect the physical layer AIS, the generation of an MPLS defect may be prevented, and when the Ethernet AIS is detected, the generation of an Ethernet defect may be prevented.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 illustrates a structure of a virtual private wire service (VPWS) system using synchronous digital hierarchy (SDH)/synchronous optical network (SONET) to which the present invention is applied;

FIG. 2 illustrates a layer-specific maintenance signal system;

FIG. 3 illustrates a format of a VPWS-operation, administration, and maintenance (OAM) packet;

FIG. 4 illustrates a format of an Ethernet-OAM packet;

FIG. 5 illustrates a format of a VPWS packet;

FIG. 6 is a block diagram showing a process of mapping the VPWS packet illustrated in FIG. 5 to an SDH signal and vice versa;

FIG. 7 is a block diagram illustrating a layer-specific maintenance signal propagation process when a physical defect occurs between an ingress node and a transit node according to an exemplary embodiment of the present invention;

FIG. 8 is a block diagram illustrating a layer-specific maintenance signal propagation process when a physical defect occurs between a transit node and an egress node according to an exemplary embodiment of the present invention;

FIG. 9 is a flowchart showing a process of preventing generation of a multi-protocol label switching (MPLS) layer alarm when a server defect indication signal (a forward defect indication (FDI) signal, or a loss of signal (LOS) signal) is received in a VPWS-tunnel, which is an MPLS layer, according to an exemplary embodiment of the present invention; and

FIG. 10 is a flowchart showing a process of preventing generation of an Ethernet layer alarm when a server defect indication signal (an Ethernet-alarm indication signal (ETH-AIS)) is received in the Ethernet layer according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below and can be implemented in various forms. Therefore, the present exemplary embodiments are provided for complete disclosure of the present invention and to fully inform the scope of the present invention to those of ordinary skill in the art.

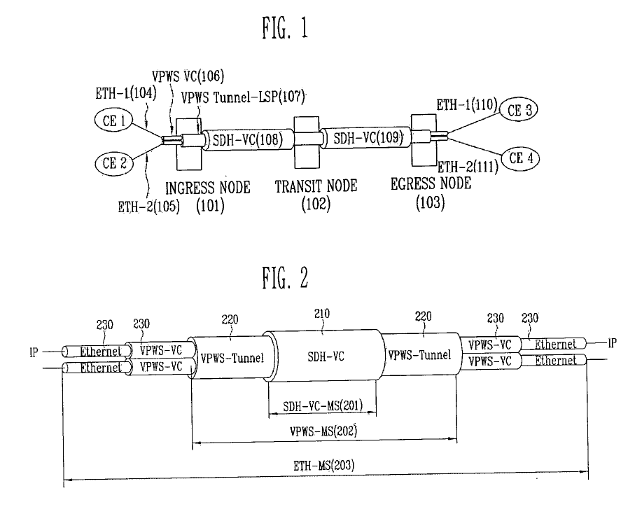

FIG. 1 illustrates a structure of a virtual private wire service (VPWS) system using synchronous digital hierarchy (SDH)/synchronous optical network (SONET) to which the present invention is applied. As illustrated in FIG. 1, the VPWS system includes an ingress node 101, a transit node 102, and an egress node 103. The ingress node 101 maps ETH-1 104 and ETH-2 105 that are Ethernet media access control (MAC) signals of subscriber devices CE1 and CE2 to a VPWS-virtual circuit (VC) 106 and a VPWS-tunnel 107, and then maps the VPWS-tunnel 107 to a first SDH-VC 108. The transit node 102 extracts the VPWS-tunnel 107 from the first SDH-VC 108 and performs label swapping on it, and then maps it to a second SDH-VC 109. The egress node 103 performs a reverse process of the ingress node 101.

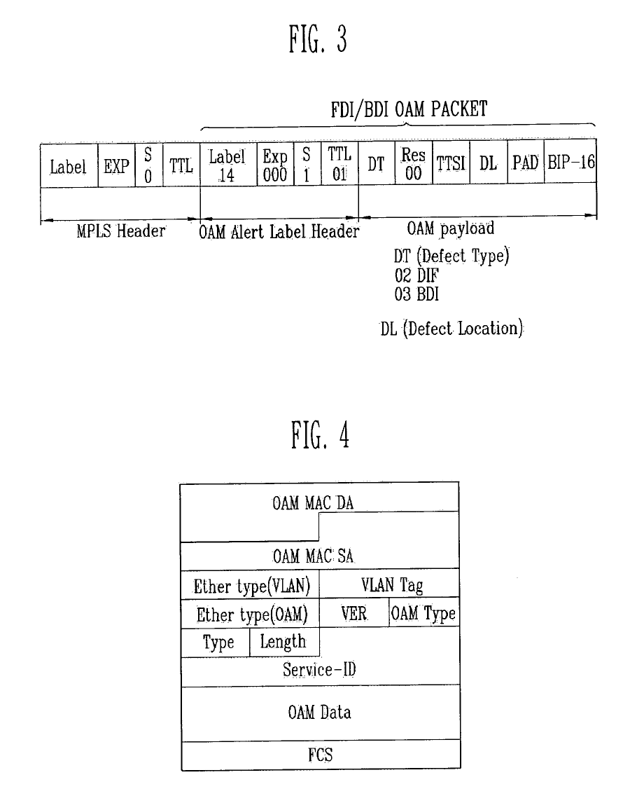

FIG. 2 illustrates a layer-specific maintenance signal system in VPWS using SDH/SONET. As illustrated in FIG. 2, maintenance signals (MSs) includes an SDH-VC-MS 201 in an SDH-VC 210 that is a physical layer, a VPWS-MS 202 for a VPWS-tunnel in an MPLS layer 220, and an ETH-MS 203 in an Ethernet layer 230.

In the present invention, in order to systemically propagate a maintenance signal from the physical layer to the Ethernet layer in the VPWS using SDH/SONET as the physical layer, the SDH-VC-MS 201 includes a VC-AIS and a VC-RDI signal, the VPWS-MS 202 includes a VPWS-FDI signal and a VPWS-backward defect indication (BDI) signal, and the ETH-MS 203 includes an ETH-AIS and an ETH-RDI signal.

In addition, in order to transmit the maintenance signal, a path overhead (POH) in an synchronous transport module level (STM-N) frame is used in the SDH-VC 210, which is the physical layer, an MPLS-operation, administration and maintenance (OAM) packet is used in the MPLS layer 220, and an Ethernet-OAM packet is used in the Ethernet layer 230.

However, when an MPLS label switched path (LSP) is established in a single direction, a “return path” is required for transferring a BDI signal.

FIG. 3 illustrates a structure of a VPWS-OAM packet for carrying a VPWS-MS in an MPLS layer, recommended by International Telecommunication Union-Telecommunication standardization sector (ITU-T) Y.1711. As illustrated in FIG. 3, a packet is recognized as an FDI signal when a defect type (DT) value is set to “02,” and is recognized as a BDI signal when the DT value is set to “03.” In addition, when a defect occurs in an MPLS LSP, defect location (DL) indicates a location at which the defect has initially occurred.

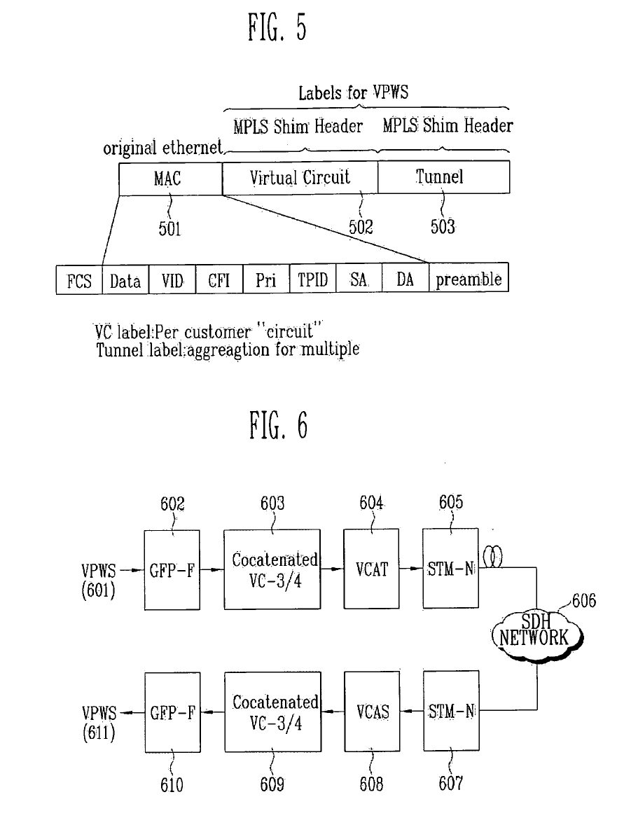

FIG. 4 illustrates a structure of an Ethernet-OAM packet format. The structure shown in FIG. 4 is an Ethernet-OAM packet for carrying an ETH-MS in an Ethernet layer and is currently being developed by ITU-T. The Ethernet-OAM packet may be set as an AIS when an OAM type value is set to “0x0A,” and as an RDI signal when the OAM type value is set to “0x0B.”

FIG. 5 illustrates a structure of a VPWS packet format. As illustrated in FIG. 5, in a frame structure of a VPWS defined by Internet Engineering Task Force (IETF), an Ethernet MAC frame 501 excluding a preamble and a frame check sequence (FSC) is mapped to the VPWS. Here, the Ethernet MAC signal is encapsulated by a VC 502, and an MPLS shim header 503 for a VPWS-tunnel is added for aggregating a plurality of VCs.

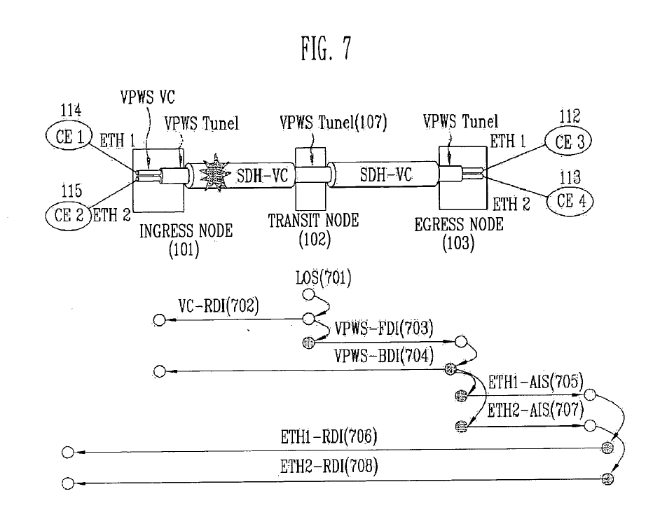

FIG. 6 illustrates a process of mapping the VPWS packet illustrated in FIG. 5 to an SDH signal. As illustrated in FIG. 6, the VPWS packet is mapped to generic frame procedure frame base (GFP-F) 602 recommended by ITU-T G.7041 and further mapped to a concatenated virtual container 603 in order to form an STM-N frame. Subsequently, a container VC-3/4 is divided into a plurality of VC-3/4s and assigned to a virtual concatenated group (VCGs) using virtual concatenation (VCAT) 604 so that the packet is switched in units of a virtual container through an SDH network, such as a digital cross connect (DXC) network.

The obtained VCGs are multiplexed into an STM-N signal by an STM-N unit 605, and the STM-N signal is transmitted to a counterpart's optical transmission device through an SDH network 606.

Subsequently, a receiver of the SDH optical transmission system extracts a VPWS 611 signal from an STM-N signal 607 transferred from the SDH network 606, through reverse processes 608 to 610 of the above-described transmission process. In this way, an Ethernet signal is mapped to a VPWS signal, and the VPWS signal is mapped to an SDH frame. Thus, a VPWS over SDH service can be provided.

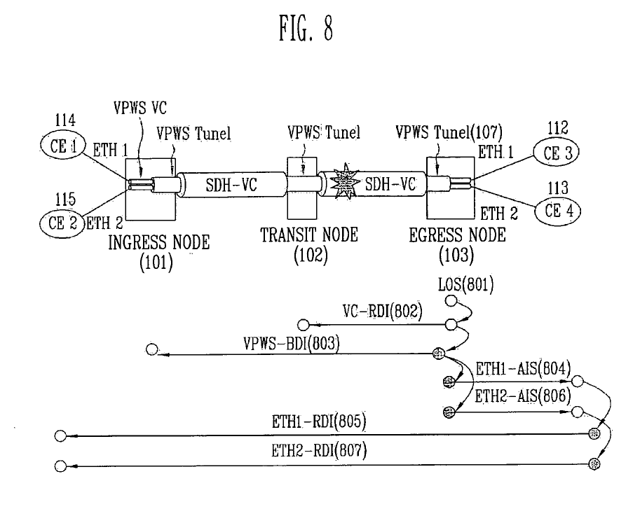

FIG. 7 illustrates a maintenance signal propagation process performed in each layer when a physical defect occurs in an SDH/SONET layer between the ingress node 101 and the transit node 102 of FIG. 1 according to an exemplary embodiment of the present invention. Referring to FIG. 7, when loss of optical signal (LOS) 701 is detected in the SDH layer, the transit node 102 generates a VC-AIS signal (not shown) and a VC-RDI signal 702, propagates the VC-AIS signal to an MPLS layer and transmits the VC-RDI signal 702 back to the ingress node 101.

When the VC-AIS signal is detected in the MPLS layer, the transit node 102 sets FDI in DT of the MPLS-OAM packet illustrated in FIG. 3, and generates a VPWS-FDI signal 703 having DL including location information of the transit node 102 at which the defect is detected and transmits it to the egress node 103.

Upon receipt of the VPWS-FDI signal 703, the egress node 103 generates and transmits a VPWS-BDI signal 704 to the ingress node 101. The egress node 103 sets AIS in the OAM type field of the Ethernet OAM packet shown in FIG. 4 and transmits an ETH1-AIS 705 and an ETH2-AIS 707 to Ethernet subscriber devices CE3 112 and CE4 113, respectively. Upon receipt of the ETH-AISs, CE3 and CE4 set RDI in the OAM type field of the Ethernet OAM packet described above, and transmit an ETH1-RDI signal 706 and an ETH2-RDI signal 708 to Ethernet subscriber devices CE1 114 and CE2 115 at the ingress node 101, respectively.

In this way, it is possible to propagate a maintenance signal to an MPLS layer and an Ethernet subscriber as well as the physical layer upon physical layer defect, and thus to monitor an Ethernet MAC flow for each subscriber.

Meanwhile, the ingress node 101 can recognize that a defect has occurred in the physical layer, the MPLS LSP layer, and the Ethernet layer, based on the received VC-RDI, VPWS-BDI, and ETH-RDI signals, and perform a layer-specific protection switching function or a protection/restoration function to protect traffic.

FIG. 8 illustrates a maintenance signal propagation process performed in each layer upon physical defect between the transit node 102 and the egress node 103 according to an exemplary embodiment of the present invention. As illustrated in FIG. 8, when LOS 801 is detected at the egress node 103, an SDH layer sends a VC-RDI signal 802 back to the transit node 102. With respect to the VPWS-tunnel 107, the SDH layer sets BDI in the DT of the MPLS-OAM packet of FIG. 3, loads into the DL the location information of the egress node 103 at which a defect is detected, and sends a VPWS-BDI signal 803 to the ingress node 101 using a return path for the tunnel.

Simultaneously, with respect to an Ethernet MAC frame encapsulated in a VPWS packet, the egress node 103 sets AIS in the OAM type field of the Ethernet OAM packets shown in FIG. 4 and sends an ETH1-AIS 804 and an ETH2-AIS 806 to Ethernet subscriber devices CE3 112 and CE4 113, respectively. Upon receipt of the ETH-AISs, the CE3 and CE4 set RDI in the OAM type field of the Ethernet OAM packet as described above, and send ETH1-RDI 805 and ETH2-RDI 807 to Ethernet subscriber devices CE1 114 and CE2 115 of the ingress node 101, respectively.

In this way, it is possible to propagate a maintenance signal to an MPLS layer and an Ethernet layer as well as a physical layer upon physical layer defect, and thus to monitor defect in a flow for each Ethernet subscriber.

Meanwhile, the ingress node 101 can recognize that a defect has occurred in the physical layer, the MPLS LSP layer, and the Ethernet layer, based on the received VC-RDI, VPWS-BDI, and ETH-RDI signals, and perform a layer-specific protection switching function or a protection/restoration function to protect traffic.

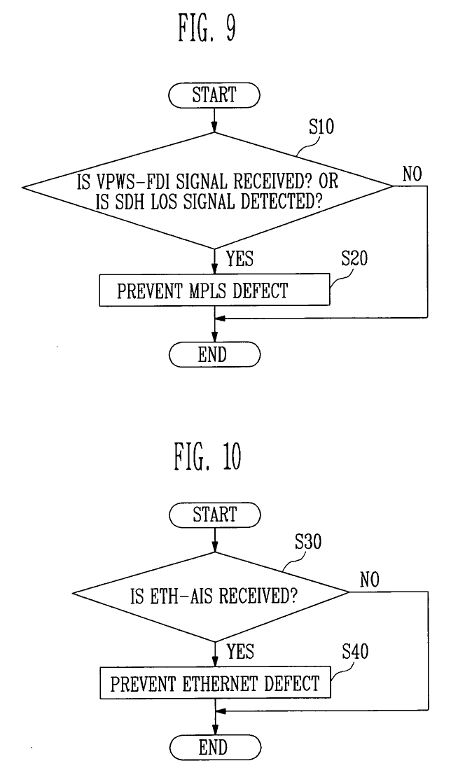

FIG. 9 is a flowchart showing a process of preventing generation of an MPLS layer alarm when a server defect indication signal (an FDI signal or an LOS signal) is received in a VPWS-tunnel, which is an MPLS layer, according to an exemplary embodiment of the present invention. The flowchart shows a method for preventing a defect when the transit node 102 detects an LOS signal in an SDH physical layer and the egress node 103 receives an FDI signal.

Referring to FIG. 9, when a defect has occurred between the ingress node 101 and the transit node 102, the transit node 102 detects a LOS signal and simultaneously inserts an FDI signal into a VPWS that is a MPLS layer, so that the egress node 103 can detect the FDI signal (S10).

However, when a defect has occurred at a previous stage of the egress node 103, it is not required to insert an FDI signal into the MPLS layer because the MPLS layer terminates at the egress. Therefore, a VPWS defect is prevented using the LOS signal of the SDH layer (S20).

FIG. 10 is a flowchart showing a process of preventing generation of an Ethernet layer alarm when a server defect indication signal (ETH-AIS) is received in an Ethernet layer.

When an ETH-AIS is received, it is recognized in advance that a defect has occurred in an MPLS layer or an SDH layer, which is a server layer of an Ethernet. Therefore, when an ETH-AIS is received (S30), an Ethernet defect is prevented (S40).

As described above, the method for propagating a maintenance signal in a VPWS network using SDH/SONET according to the present invention has following effects.

First, maintenance signals for layers systemically interwork upon physical defect in accommodating Ethernet subscribers using an SDH as a physical layer of a VPWS. Accordingly, a network maintenance function, which could be performed only by a transmission device of layer 1 such as conventional SDH/SONET or optical transport hierarchy (OTH), can extend to an MPLS layer and Ethernet layer. Therefore, Ethernet lines can be managed by customer edge (CE) equipment as well as provider edge (PE) equipment managed by a network provider.

Second, when a defect occurs in a physical layer, it can be recognized that a defect has occurred in server layers of the upper layers, i.e., an MPLS layer and an Ethernet layer (an SDH layer in case of the MPLS layer, and the MPLS layer in case of the Ethernet layer). Thus, only the SDH layer at which a first defect has occurred is allowed to report the defect, thereby preventing too frequent generation of alarms in a control channel for network management.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for propagating a maintenance signal in a virtual private wire service (VPWS) network, comprising the steps of:
when a physical defect signal is detected from a physical layer, generating physical layer maintenance signals including a physical layer alarm indication signal (AIS) and a physical layer remote defect indication (RDI) signal, and transmitting the physical layer maintenance signals to a neighbor node in the backward direction of traffic;
when the physical AIS is detected, generating and transmitting, at a multi-protocol label switching (MPLS) layer, a VPWS-BDI (backward defect indication) signal indicating a backward defect to an ingress node, and generating and transmitting, at an Ethernet layer, an Ethernet AIS to an Ethernet subscriber device connected to an egress node; and
generating and transmitting, at the Ethernet subscriber device receiving the Ethernet AIS, an Ethernet RDI signal to an Ethernet subscriber device connected to the ingress node.

2. The method according to claim 1, wherein the VPWS-BDI signal generated at the MPLS layer has an MPLS-operation, administration, and maintenance (OAM) packet structure, and wherein a backward defect or a forward defect is set in a defect type field of the MPLS-OAM packet, and identification information of a node at which a first physical defect is detected is recorded in a defect location field.

3. The method according to claim 1, wherein the Ethernet AIS and RDI signals generated at the Ethernet layer have an Ethernet-operation, administration, and maintenance (OAM) packet structure.

4. The method according to claim 1, wherein when the physical defect signal is detected at the ingress node, the physical layer RDI signal is transmitted to a transit node.

5. The method according to claim 1, wherein when the physical defect signal is detected at a transit node, the physical layer RDI signal is transmitted to the ingress node.

6. The method according to claim 5, wherein the MPLS layer generates and transmits a VPWS-FDI (forward defect indication) signal indicating a forward defect to the egress node, and the Ethernet layer of the egress node receiving the VPWS-FDI signal generates and transmits the Ethernet AIS to the Ethernet subscriber device connected to the egress node.

7. The method according to claim 6, wherein the egress node receiving the VPWS-FDI signal indicating a forward defect prevents generation of an MPLS defect.

8. The method according to claim 4, wherein the egress node prevents generation of an MPLS defect.

9. The method according to claim 1, wherein when the Ethernet AIS is detected, generation of an Ethernet defect is prevented.
